(19) United States
(12) Patent Application Publication
(10) Pub. No.: US 2003/0184564 A1
(43) Pub. Date: Oct. 2, 2003

(54) Method for simulating a celestial sphere in real-time within a data processing system

(75) Inventors: Russell G. Torti, Arlington, TX (US); Stephen M. Guest, Benbrook, TX (US)

Correspondence Address: ANTONY P. NG, BRACEWELL & PATTERSON LLP, 7600B NORTH CAPITAL OF TEXAS HIGHWAY, SUITE 350 LAKEWOOD ON THE PARK, AUSTIN, TX, 78731-1168, US

(73) Assignee: Lockheed Martin Corporation

(21) Appl. No.: 10/113,242

(22) Filed: Apr. 1, 2002

(51) Int. Cl. G06G 7/48; G09G 5/00

(52) U.S. Cl. 345/633

(57) ABSTRACT

A method for simulating a celestial sphere in real-time within a data processing system is disclosed. Initially, information of an observer, such as date, time and longitude/latitude positions, are obtained. Then, a Julian Day and a Greenwich mean sidereal time are determined from the above-mentioned information. A local mean sidereal time is subsequently determined. Furthermore, a tilt angle about a celestial equator of a celestial sphere is determined by using the latitudinal position of the observer. The determined values provide a real-time representation of the position of the celestial sphere relative to the observer at a specific position on the earth.

### BACKGROUND OF THE INVENTION

1. Technical Field

The present invention relates to data processing in general, and in particular to graphics simulation within a data processing system. Still more particularly, the present invention relates to a method for simulating a celestial sphere in real-time within a data processing system.

2. Description of the Related Art

One of the major goals of graphics simulation within a data processing system is to provide a visual image that looks as realistic as possible. For example, when simulating a night sky, instead of using some randomly generated stars, the constellation can be represented by a celestial sphere. A celestial sphere is an imaginary sphere of infinite radius with the earth located at its center. Stars grouped into well-known constellations of the zodiac were assumed to be affixed to the celestial sphere that rotates in a clockwise or easterly direction relative to the earth. The only apparent motion of the fixed stars is in circular paths called diurnal circles, due to the daily rotation of the celestial sphere, which is now known to be caused by the earth's rotation.

The stars on a celestial sphere completes one revolution in a sidereal day. A sidereal day, which has a period of 23 hours, 56 minutes, and 3 seconds, is about 4 minutes shorter than the 24-hour civil day based on the position of the sun. The moon can also be represented on a celestial sphere, but like the sun moves slowly eastward across the celestial sphere, due to its orbit about the earth. The plane of its orbit assumes an angle of about 5.2 degrees with respect to the ecliptic, with the moon completing one orbit in about 27.322 civil days to define a sidereal month. While the sidereal month accurately represents the cycle of change of the position of the moon on the celestial sphere, a synodic month accurately represents the cycle of the lunar phases, having a period of about 29.531 civil days. In that period of time, the moon proceeds from the phase of a new moon to a full moon and back again to a new moon.

Similar to the well-known longitude-latitude coordinate system used to determine positions on the surface of the earth, an equatorial coordinate system is used to determine the position of a star on the celestial sphere. As the true distance of all stars are light-years away from the earth, the celestial sphere model is sufficiently accurate for many viewing purposes, including graphics simulation.

The present disclosure provides a method for simulating a celestial sphere in real-time within a data processing system.

### SUMMARY OF THE INVENTION

In accordance with a preferred embodiment of the present invention, information of an observer, such as date, time and longitude/latitude positions, are initially obtained. Then, a Julian Day and a Greenwich mean sidereal time are determined from the above-mentioned information. A local mean sidereal time is subsequently determined. Furthermore, a tilt angle about a celestial equator of a celestial sphere is determined by using the latitudinal position of the observer. The determined values provide a real-time representation of the position of the celestial sphere relative to the observer at a specific position on the earth.

All objects, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a graphical illustration of a celestial sphere, in accordance with a preferred embodiment of the present invention;

FIG. 2 is a high-level logic flow diagram of a method for simulating a celestial sphere in real-time within a data processing system, in accordance with a preferred embodiment of the present invention; and

is FIG. 3 is a block diagram of a data processing system in which a preferred embodiment of the present invention can be implemented.

### DETAILED DESCRIPTION OF A PREFERRED EMBODIMENT

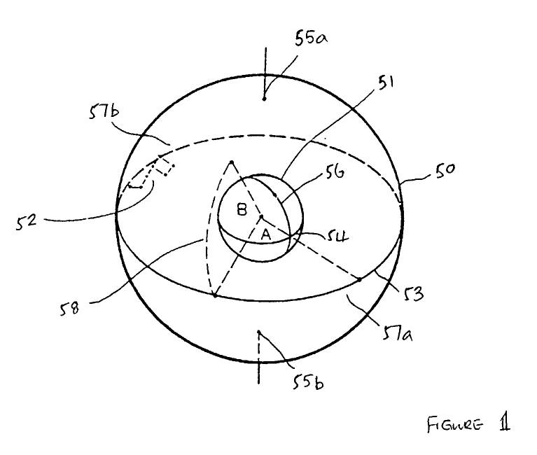

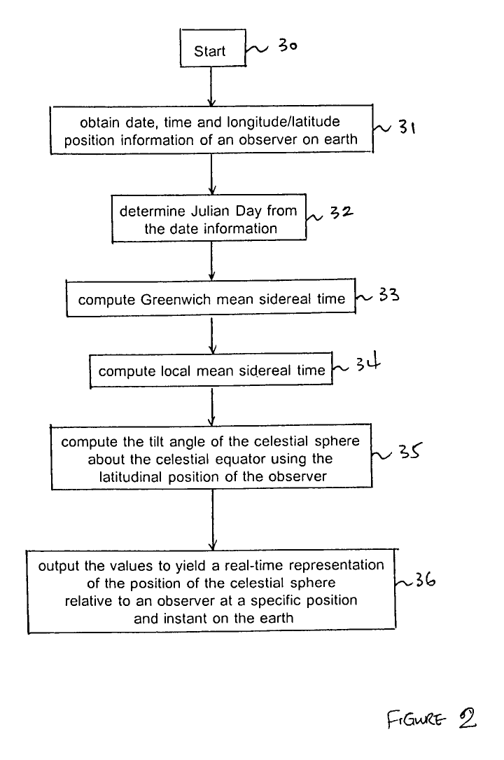

Referring now to the drawings and in particular to FIG. 1, there is a graphical illustration of a celestial sphere, in accordance with a preferred embodiment of the present invention. As shown, a celestial sphere 50 is an imaginary sphere of infinite radius with an earth 51 located at its center. Stars grouped into well-known constellations 52 were assumed to be affixed to celestial sphere 50 that rotates in an easterly direction relative to earth 51, completing one revolution in a sidereal day. An equatorial coordinate system is used to determine the position of a star on celestial sphere 50.

The celestial latitude (or declination A) of a star is measured from a celestial equator 53 of celestial sphere 50, which is defined by the projection of an equator 54 of earth 51. Celestial latitudes are measured in degrees from 0 degree on celestial equator 53 to + or −90 degrees to the respective north and south celestial poles, 55a and 55b. Longitude co-ordinates on earth 51 are defined in terms of degrees east or west of the prime meridian circle 56 passing through Greenwich Observatory located in England. However, on the celestial sphere 50, a different co-ordinate system based on a vernal equinox 57a is used. Vernal equinox 57a and an autumnal equinox 57b are defined by the intersection of celestial equator 53 and the circle of an ecliptic 58. Ecliptic 58 represents the apparent path of the sun around celestial sphere 50. As earth 51 revolves around the sun, the sun appears to shift slowly eastward from its position in the sky, returning to the same position after a sidereal year. A sidereal year has a period of about 365.265 civil days, which is approximately six hours more than a 365-day civil year.

Ecliptic 58 assumes an angle of about 23.5 degrees with respect to celestial equator 53 due to the tilt of earth 51's axis relative to the rotational plane of its orbit about the sun. Autumnal and vernal equinoxes, 57a and 57b, correspond to the times in fall season and spring season, respectively, when the sun is at celestial equator 53 such that days and nights are of equal duration. The celestial longitude (or right ascension B) of a celestial object is measured in terms of hours, minutes and seconds from the vernal equinox instead of degrees, with one hour being the equivalent of 15 degrees, 24 hours equaling a full 360 degree sweep back to the origin.

The moon (not shown) can also be represented on celestial sphere 50. Like the sun, the moon moves slowly eastward across celestial sphere 50, due to its orbit about earth 51. The plane of its orbit assumes an angle of about 5.2 degrees with respect to ecliptic 58, with the moon completing one orbit in about 27.322 civil days to define a lunar month.

The present invention utilizes a celestial sphere representation, such as celestial sphere 50, to simulate the motion of the stars in the sky. The fundamental assumption of the method of the present invention is to consider the earth stationary while the celestial sphere rotates about the earth. Such an assumption is valid in the limit of near earth positions, since the nearest celestial object is multiple light years away from the earth. The motion of the celestial sphere with respect to an observer on earth can be determined using the following steps.

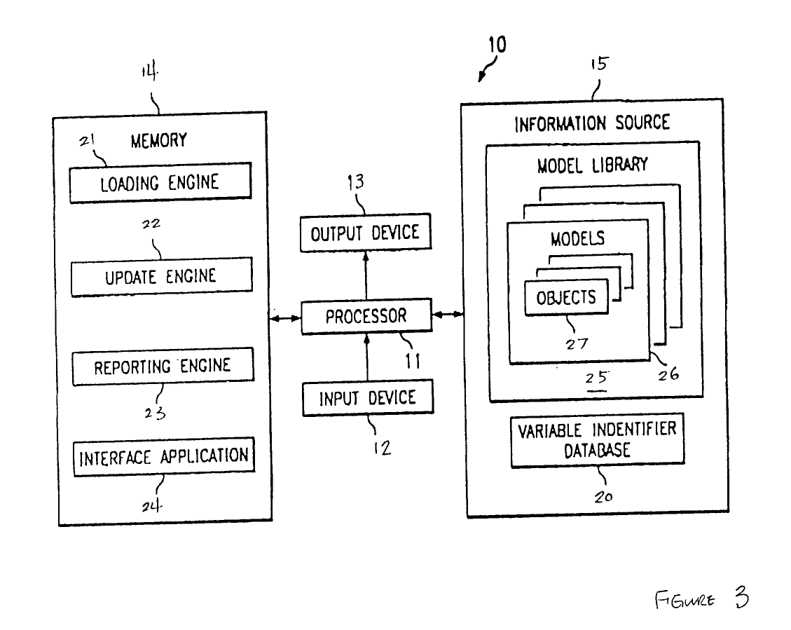

With reference now to FIG. 2, there is depicted a high-level logic flow diagram of a method for simulating a celestial sphere, such as celestial sphere 50 from FIG. 1, in real-time within a data processing system, in accordance with a preferred embodiment of the present invention. Starting at block 30, information of an observer on earth, such as date (i.e. year, month and day), time and longitude/latitude position, are obtained, as shown in block 31. Then, the Julian Day is determined from the above-mentioned date information, as depicted in block 32. The Julian Day is defined as the number of fractional days since the year −4712. The Julian Day begins at noon in Greenwich, England. The equation for determining the Julian Day is as follows:

$$JD = INT [ 365.25 \times year ] + INT [ 30.6001 \times ( month + 1 ) ] - 15 + \frac{1720996.5 + day + UT}{24}$$

where

year=Gregorian year in four digits;

month=month+12; and

UT=the universal time at Greenwich, England.

Year, month and day are all Gregorian values. If month≦2, then year=year−1.

Next, the Greenwich mean sidereal time is computed, as shown in block 33. The Greenwich mean sidereal time is the sidereal time at the meridian of Greenwich, England at a given universal time on a given date. The equation for determining the mean sidereal time at Greenwich, England for a given date and time can be provided by the following expression:

θ₀=C2−|C|

where

C=280.46061837+360.98564736629×(JD−2455198.0)+(0.000387933×t²)−(t³/387100000);

t=(JD−2455198.0)/36525.0;

JD=the previously calculated Julian Day;

C2=Ceil[C1]×360; and

C1=|C/360|.

Then, the local mean sidereal time is calculated, as depicted in block 34. The local mean sidereal time is the local sidereal time at the meridian of the observer at a given universal time and date. The local mean sidereal time indicates how much the celestial sphere must be rotated about the north celestial pole in degrees to achieve the proper orientation. The standard position, zero sidereal hour, is the vernal equinox at noon, March 21 of any year. The equation for determining the local mean sidereal time is:

H=θ₀−longitude

where

θ₀=the Greenwich mean sidereal time;

longitude=the observer's longitudinal position in degrees.

Next, the tilt angle of the celestial sphere about the celestial equator is calculated using the latitudinal position of the observer, as shown in block 35. The equation for the tilt angle of the celestial sphere is given by:

tiltangle=90(degrees)−longitude

Finally, the values are output and utilized to yield a real-time representation of the position of the celestial sphere relative to an observer at a specific position and instant on the earth, as depicted in block 36. The values are then recalculated and updated on a continuous basis.

The present invention may be executed in a variety of computers under a number of different operating systems. The computer may be, for example, a personal computer, a midrange computer or a mainframe computer. In addition, the computer may be a stand-alone system or part of a network such as a local-area network (LAN) or a wide-area network (WAN).

Referring now to FIG. 3, there is illustrated a block diagram of a data processing system in which a preferred embodiment of the present invention is applicable. As shown, a data processing system 10 includes a processor 11, an input device 12, an output device 13, a memory 14, and an information source 15. Information, such as variable value data, may be received from a user via input device 12 such as a keyboard. Output values or results may be output to the user via output device 13 such as a display.

By way of example, information source 15 may comprise a model library 25 having one or more models 26 that may be selected by the user via input device 12. Each of models 26 include one or more cooperative collections of objects 27 to provide a simulation or analysis of selected information. However, models 26 may be otherwise configured to provide analysis, simulation or other user defined information processing parameters. Objects 27 generally include data sets, data tables, or functions for processing information according to a selected one of models 26. Each object 27 represents an instance of some class, and whose classes are all members of a hierarchy of classes united via inheritance relationships. Each object 27 includes an input variable and an output variable. Each object 27 is an identifiable, encapsulated piece of code and data that provide one or more services when requested by the user. Thus, based on an input variable value, object 27 provides an output variable value corresponding to the table, data set or function of object 27.

Information source 15 may also include a variable identifier database 20 having a unique identifier associated with each input variable and output variable of objects 27. For example, the unique identifier may include terminology, alphanumeric designations, phrases or other suitable identifiers to identify particular input variables and output variables of objects 27.

Software programs, such as a loading engine 21, an update engine 22, a reporting engine 23, and an interface application 24, are illustrated as being stored in memory 14 where they can be executed by processor 11. Loading engine 21, update engine 22, reporting engine 23, and interface application 24 may also be stored on a variety of other types of storage media.

Loading engine 21 processes information from information source 15 in preparation for evaluation of the information using update engine 22. Loading engine 21 automatically creates object links between each of the input variables and output variables of objects 27 of a selected one of models 26. Loading engine 21 may access variable identifier database 20 for each object 27 included within a particular one of models 26 to automatically determine the input and output variable of objects 27 and automatically link corresponding input and output variables of the objects 27.

Update engine 22 processes models 26 and automatically updates each object within a model sequentially to obtain output variable values of the user-selected model based on user-defined input variable values. For example, update engine 22 sequentially updates each object of a model to obtain output variable values for each of objects 27 without performing redundant calculations. Thus, a particular one of objects 27 may be updated when an output variable value of the updated object is required to support the update of another one of objects 27.

Reporting engine 23 may be used to display output variable values of a particular one of models 26 to the user via output device 13. For example, reporting engine 23 may provide output variable values in a particular format or structure as defined by the user via input device 12. However, reporting engine 23 may be otherwise used to display or provide output variable values to the user.

Interface application 24 may be used to receive input variable values from the user via input device 12 and automatically associate the data or input variable values received from the user to corresponding input variables of objects 27. However, input variable values may be otherwise received and associated with the corresponding input variables of objects 27.

As has been described, the present invention provides a method and system for simulating a celestial sphere in real-time within a data processing system.

While the invention has been particularly shown and described with reference to a preferred embodiment, it will be understood by those skilled in the art that various changes in form and detail may be made therein without departing from the spirit and scope of the invention.

What is claimed is:

1. A method for simulating a celestial sphere in real-time within a data processing system, said method comprising:
obtaining date, time, and longitude/latitude position information of an observer on earth;
determining a Julian Day from said date information;
determining a Greenwich mean sidereal time;
determining a local mean sidereal time;
determining a tilt angle of said celestial sphere about a celestial equator using said latitude position of said observer; and
utilizing the above-determined values to yield a real-time representation of a position of said celestial sphere relative to said observer on earth.

2. The method of claim 1, wherein said determining a Julian Day is performed by
$$JD = INT [ 365.25 \times year ] + INT [ 30.6001 \times ( month + 1 ) ] - 15 + \frac{1720996.5 + day + UT}{24}$$
where year=Gregorian year in four digits, month=month+12; if month≦2, then year=year−1; and UT=the universal time at Greenwich, England.

3. The method of claim 1, wherein said determining a Greenwich mean sidereal time is performed by
θ₀=C2−|C|

where
C=280.46061837+360.98564736629×(JD−2455198.0)+(0.000387933×t²)−(t³/387100000);
t=(JD−2455198.0)/36525.0;
JD=the previously calculated Julian Day;
C2=Ceil[C1]×360; and
C1=|C/360|.

4. The method of claim 1, wherein said determining a local mean sidereal time is performed by
H=θ₀−longitude
where θ₀ is said Greenwich mean sidereal time, and longitude is said observer's longitudinal position in degrees.

5. The method of claim 1, wherein said determining a tilt angle of said celestial sphere is performed by
tiltangle=90(degrees)−longitude

6. A computer program product residing on a computer usable medium for simulating a celestial sphere in real-time within a data processing system, said computer program product comprising:
program code means for obtaining date, time, and longitude/latitude position information of an observer on earth;
program code means for determining a Julian Day from said date information;
program code means for determining a Greenwich mean sidereal time;
program code means for determining a local mean sidereal time;
program code means for determining a tilt angle of said celestial sphere about a celestial equator using said latitude position of said observer; and
program code means for utilizing the above-determined values to yield a real-time representation of a position of said celestial sphere relative to said observer on earth.

7. The computer program product of claim 6, wherein said program code means for determining a Julian Day further includes
$$JD = INT [ 365.25 \times year ] + INT [ 30.6001 \times ( month + 1 ) ] - 15 + \frac{1720996.5 + day + UT}{24}$$
where year=Gregorian year in four digits, month=month+12; if month≦2, then year=year−1, and UT=the universal time at Greenwich, England.

8. The computer program product of claim 6, wherein said program code means for determining a Greenwich mean sidereal time is performed by
θ₀=C2−|C|

where
C=280.46061837+360.98564736629×(JD−2455198.0)+(0.000387933×t²)−(t³/387100000);
t=(JD−2455198.0)/36525.0;
JD=the previously calculated Julian Day;
C2=Ceil[C1]×360; and
C1=|C/360|.

9. The computer program product of claim 6, wherein said program code means for determining a local mean sidereal time is performed by
H=θ₀−longitude
where θ₀ is said Greenwich mean sidereal time, and longitude is said observer's longitudinal position in degrees.

10. The computer program product of claim 6, wherein said program code means for determining a tilt angle of said celestial sphere is performed by
tiltangle=90(degrees)−longitude

11. A data processing system capable of simulating a celestial sphere in real-time, said data processing system comprising:
means for obtaining date, time, and longitude/latitude position information of an observer on earth;
means for determining a Julian Day from said date information;
means for determining a Greenwich mean sidereal time;
means for determining a local mean sidereal time;
means for determining a tilt angle of said celestial sphere about a celestial equator using said latitude position of said observer; and
means for utilizing the above-determined values to yield a real-time representation of a position of said celestial sphere relative to said observer on earth.

12. The data processing system of claim 11, wherein said determining a Julian Day is performed by
$$JD = INT [ 365.25 \times year ] + INT [ 30.6001 \times ( month + 1 ) ] - 15 + \frac{1720996.5 + day + UT}{24}$$
where year=Gregorian year in four digits, month=month+12; if month≦2, then year=year−1, and UT=the universal time at Greenwich, England.

13. The data processing system of claim 11, wherein said means for determining a Greenwich mean sidereal time is performed by
θ₀=C2−|C|

where
C=280.46061837+360.98564736629×(JD−2455198.0)+(0.000387933×t²)−(t³/387100000);
t=(JD−2455198.0)/36525.0;
JD=the previously calculated Julian Day;
C2=Ceil[C1]×360; and
C1=|C/360|.

14. The data processing system of claim 11, wherein said means for determining a local mean sidereal time is performed by
H=θ₀−longitude
where θ₀ is said Greenwich mean sidereal time, and longitude is said observer's longitudinal position in degrees.

15. The data processing system of claim 1, wherein said means for determining a tilt angle of said celestial sphere is performed by
tiltaiigle 90(degrees)−longitude
